(19) United States
(12) Patent Application Publication
(10) Pub. No.: US 2020/0012923 A1
(43) Pub. Date: Jan. 9, 2020

(54) COMPUTER DEVICE FOR TRAINING A DEEP NEURAL NETWORK

(71) Applicant: SIEMENS AKTIENGESELLSCHAFT, München (DE)

(72) Inventors: Sanjukta Ghosh, Schwaig bei Nürnberg (DE); Peter Amon, München (DE); Andreas Hutter, München (DE)

(21) Appl. No.: 16/340,114

(22) PCT Filed: Sep. 5, 2017
(86) PCT No.: PCT/EP2017/072210

§ 371 Date: Apr. 6, 2019

(30) Foreign Application Priority Data
Oct. 6, 2016 (IN) 201611034299

(51) Int. Cl. G06N 3/04; G06N 3/08; G06K 9/00; G06K 9/62

(52) U.S. Cl. CPC G06N 3/0472; G06K 9/6267; G06K 9/00369; G06N 3/084

(57) ABSTRACT

A computer device for training a deep neural network is provided. The computer device includes a receiving unit for receiving a two-dimensional input image frame, and a deep neural network for examining the two-dimensional input image frame in view of objects being included in the two-dimensional input image frame. The deep neural network includes a plurality of hidden layers and an output layer representing a decision layer. The computer device includes a training unit for training the deep neural network using transfer learning based on synthetic images for generating a model comprising trained parameters, and an output unit for outputting a result of the deep neural network based on the model.

This application is the National Stage of International Application No. PCT/EP2017/072210, filed Sep. 5, 2017, which claims the benefit of Indian Patent Application No. 201611034299, filed on Oct. 6, 2016. The entire contents of these documents are hereby incorporated herein by reference.

### BACKGROUND

The present embodiments relate to training a deep neural network.

Counting of objects (e.g., pedestrians or cars in surveillance applications) is a common scenario. Deep neural networks have been successfully used for numerous applications for visual sensor data. The models generated by training deep neural networks have been shown to learn useful features for different tasks like object detection, classification, and a host of other applications. Deep neural networks provide a framework that support end-to-end learning. While one may train a network to detect the pedestrians first and then count the pedestrians, the possibility of counting the pedestrians directly exists. It is often challenging to obtain sufficient annotated training data, especially for creating models using deep learning that require a large amount of training data.

Y. Fujii, S. Yoshinaga, A. Shimada, and R. Ichiro Taniguchi, “The 1st international conference on security camera net-work, privacy protection and community safety 2009 real-time people counting using blob descriptor,” Procedia—Social and Behavioral Sciences, vol. 2, no. 1, pp. 143-152, 2010, describes to first extract candidate regions and segment into blobs. Features extracted from each blob are used to train a neural network that is the used to estimate the count of pedestrians.

Z. Yu, C. Gong, J. Yang, and L. Bai, “Pedestrian counting based on spatial and temporal analysis,” in 2014 IEEE International Conference on Image Processing (ICIP), October 2014, pp. 2432-2436 count pedestrians by doing a spatio-temporal analysis of a sequence of frames.

L. Fiaschi, U. Koethe, R. Nair, and F. A. Hamprecht, “Learning to count with regression forest and structured labels,” in Pattern Recognition (ICPR), 2012 21st International Conference on, November 2012, pp. 2685-2688 use random regression forests to estimate density of objects per pixel which are then used for counting pedestrians.

S. Segui, O. Pujol, and J. Vitria, “Learning to count with deep object features,” in The IEEE Conference on Computer Vision and PatternRecognition (CVPR) Workshops, June 2015 describes the use of CNN for counting. A model is trained on MNIST data to count the number of digits in an input image. The learnt representations are then used for other classification tasks like finding out if the digit in an input image is even or odd. Additionally, a CNN is trained for counting pedestrians in a scene. Results are reported for a network trained on data generated from the UCSD dataset and tested on frames from the UCSD dataset. A variation of the hypercolumn visualization is used to visualize the features learnt by the model.

In C. Zhang, H. Li, X. Wang, and X. Yang, “Cross-scene crowd counting via deep convolutional neural networks,” in 2015 IEEE Conference on Computer Vision and Pattern Recognition (CVPR), June 2015, pp. 833-841, a CNN is trained for cross-scene crowd counting by switching between a crowd density objective function and a crowd count objective function. This trained model is fine-tuned for a target scene using similar training data as that of the target scene, where similarity is defined in terms of view angle, scale, and density of the crowd. The view angle and scale are used to retrieve candidate scenes, and the crowd density is used to select local patches from the candidate scenes. Results are reported on the WorldExpo10 crowd counting dataset, UCSD dataset, and UCF CC 50 dataset. For the UCSD dataset, single scene crowd counting results are reported.

When using deep neural networks, these networks are to be trained in order to provide good results. For training deep neural networks, training data may be used to train the networks before the real tasks of the networks, although there is not always sufficient training data available.

An approach to solve insufficient training data is the use of transfer learning. Transfer learning involves the knowledge transfer or leveraging the knowledge learned for a source task and source distribution to solve possibly a different task with different distribution of the samples. For deep neural networks, the transferability of features has been studied, for example, in Yosinski, J., Clune, J., Bengio, Y., and Lipson, H. (2014). How transferable are features in deep neural networks? In Advances in Neural Information Processing Systems 27, pages 3320-3328. Curran Associates, Inc.

The application of transfer learning in deep neural networks is described, for example, in Ciresan, D. C., Meier, U., & Schmidhuber, J. (2012, June), Transfer learning for Latin and Chinese characters with deep neural networks, in Neural Networks (IJCNN), The 2012 International Joint Conference on (pp. 1-6), IEEE.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, an improved approach for counting objects within an image frame is provided.

A computer device for training a deep neural network is provided. The computer device includes a receiving unit for receiving a two-dimensional input image frame, and a deep neural network for examining the two-dimensional input image frame in view of objects being included in the two-dimensional input image frame. The deep neural network includes a plurality of hidden layers and an output layer representing a decision layer. The computer device also includes a training unit for training the deep neural network using transfer learning based on synthetic images for generating a model including trained parameters. The computer device includes an output unit for outputting a result of the deep neural network based on the model.

The deep neural network (e.g., a neural network) may be a convolutional neural network (CNN or ConvNet) being a type of feed-forward artificial neural network in which the connectivity pattern between neurons is inspired by the organization of the animal visual cortex, with individual neurons being arranged such that the individual neurons respond to overlapping regions tiling the visual field. Also, other kinds of deep neural networks may be used.

The neural network includes convolutional layers and fully connected layers. The convolutional layer is the core building block of a CNN. Parameters of the convolutional layer include a set of learnable filters (or kernels) that have a small receptive field, but extend through the full depth of the input volume. Neurons in a fully connected layer have full connections to all activations in the previous layer.

The neural network may include, for example, five convolutional layers and three fully connected layers, where the final fully connected layer (e.g., the highest fully connected layer) is the classifier that gives the count of the actual input image frame.

Further, rectified linear units (ReLUs) may be used as activation functions. Pooling and local response normalization layers may be present after the convolutional layers. Dropout is used to reduce overfitting.

There may be different activation functions used at the output of a linear neuron to introduce non-linearity. A possible activation function is a ReLU, which computes the function f(x)=max(0,x). This implies that there is a threshold at zero. There exist variants to the ReLU (e.g., parameterizing the ReLU).

Pooling generates a summary statistic of a local neighborhood, thereby also reducing the size of the representation. The local response normalization layer performs a kind of lateral inhibition by normalizing over local input regions.

Dropout is a mechanism whereby a certain percentage of the nodes in a layer are ignored at random during the training.

The respective unit (e.g., the receiving unit) may be implemented in hardware and/or in software. If the unit is implemented in hardware, the unit may be embodied as a device (e.g., as a computer or as a processor or as a part of a system such as a computer system). If the unit is implemented in software, the unit may be embodied as a computer program product, as a function, as a routine, as a program code, or as an executable object.

According to an embodiment, the output unit is configured to feed back the result of the deep neural network to the training unit.

Thus, the training unit may use the feedback for further training processes.

According to an embodiment, the training unit is configured to use an initial model of the deep neural network to initialize parameters of the deep neural network.

Thus, a basis model that may be adapted to the specific task of counting objects within an image may be used. The parameters may be, for example, a set of learnable filters (or kernels).

According to a further embodiment, the training unit is configured to perform transfer learning from an initial model to a baseline model of the deep neural network, from the baseline model to an enhanced model of the deep neural network, from the initial model to the enhanced model of the deep neural network, and/or from the enhanced model to an improved model of the deep neural network.

Thus, the training unit may perform transfer learning at different point of the deep neural network. The initial model is an existing model. This may be trained to be a baseline model or an enhanced model. The baseline model may be trained to become also the enhanced model. The enhanced model may be further fine-tuned to become an improved model.

According to a further embodiment, the computer device includes a synthetic data generator for generating the synthetic images.

After the generation of the synthetic images, the training unit is configured to train the neural network using the synthetic images.

Training data may be generated for different counts of objects. Various backgrounds from surveillance datasets and pictures of scenes may be used, for example.

As described above, synthetic images may denote that the real images may be processed to provide training data. For example, pedestrians may be extracted using pixel masks and Chroma keying. Subsequently, the pedestrians may be merged with the background at different positions. The generated synthetic images may have various scenarios of occlusion caused by the position and motion of the pedestrians relative to each other. These situations may be simulated by using different sequences of pedestrians. This provides that the absolute and relative positions of the pedestrians may change from one frame to the other for the same background.

According to a further embodiment, the deep neural network is configured to provide as result the count of the objects in the two-dimensional input image frame.

The neural network, which results in a model after the training, is configured to provide a count of objects (e.g., pedestrians) given a two-dimensional (2D) input image frame. The pedestrian counting problem may be considered as a classification problem in which the model provides the probability of belonging to each class, where each class represents a specific count. For example, if the model is trained to count a maximum of 15 pedestrians, the final layer of the neural network has 16 classes (0 to 15), where each label corresponds to the same count of the pedestrians. In this case, a function maps from the image space to a space of c dimensional vectors as

f:X→n,Xϵ [symbol] ^{W×H×D} and nϵ [symbol] ^{c}

where W and H are the width and height of the input image in terms of the number of pixels, respectively, D is the number of color channels of the image, and c is the number of classes.

In addition to the last fully connected layer, also the lower layers (or the previous layers) may be used for fine-tuning the classification of the highest layer (e.g., the last fully connected layer). Thus, the convolutional layers as well as the remaining fully connected layers may be used for fine-tuning. Fine-tuning may be done, for example, by using the background of the input image frame.

According to a further embodiment, the objects are objects before a background of the two-dimensional input image frame.

The objects may be, for example, moving objects.

According to a further embodiment, the objects are pedestrians.

Also, other moving objects, like cars or the like, may be detected and counted.

According to a further embodiment, the training unit is configured to train the deep neural network using a combination of an activation function and/or a linear neuron output in a first act and a cross entropy loss and/or a squared error loss in a second act.

The activation function may be, for example, a softmax function. In the context of the neural network as used herein, when considered as a classification problem, the softmax function is used to convert the output scores from the final fully connected layer to a vector of real numbers between 0 and 1 that add up to 1 and are the probabilities of the input belonging to a particular count. The cross entropy loss function between the output of the softmax function and the target vector is used to train the weights of the network.

Instead of the softmax function, a linear neuron output may be used. This provides that the output of the neuron including a linear processing using a weight and a bias is used without passing through an activation function.

Further, instead of the cross entropy loss, a squared error loss may be used.

According to a further embodiment, the training unit is configured to train the deep neural network using a regularization.

Additionally, a regularization factor, for example, based on the L2 norm of the weights is used to prevent the network from over-fitting. The cost function for classification is

$$L ( θ ) = - \frac{1}{N} {\sum }_{i = 1}^{N} {\sum }_{j = 1}^{C} {t}_{ij} log {y}_{ij} + \frac{λ}{2 N} {‖ w ‖}_{2}^{2}$$

where L is the loss that is a function of the parameters, θ, N is the number of training samples, C is the number of classes, y is the predicted count, t is the actual count, and w represents the weight.

As explained above, instead of the cross entropy loss function, a squared error loss function may be used.

Pairing the activation function and the cost function may ensure that the rate of convergence is not affected.

The cost function gradient with respect to weights of the final layer are proportional to the difference between the target value and the predicted value, as expressed in the equation below

$$\frac{δ L}{δ {w}_{jk}^{L}} = \frac{1}{N} {\sum }_{i = 1}^{N} ( {y}_{ij}^{L} - {t}_{ij} ) {y}_{ik}^{L - 1} + \frac{λ}{N} {‖ {w}_{jk}^{L} ‖}_{2}$$

where L denotes the output layer, wⱼₖ^{L} denotes the weight between node j of layer L and node k of layer L−1, yᵢⱼ^{L} denotes the predicted output for training example i at node j of the output layer, tᵢⱼ denotes the target output for training example i at node j of the output layer, and yᵢₖ⁻¹ denotes the output of node k of layer L−1 for training example i. As may be observed, there are no higher order terms that may result in smaller values of the gradient even when the output is of a value with the opposite sign.

According to a further embodiment, the output layer is configured to provide a classification of the objects, to provide a regression value, and/or to generate images.

According to a further embodiment, the result of the deep neural network includes at least one of a probability distribution, a single value, a decision, and images.

In the case of a classification problem, the output layer works as a classification layer and provides an estimation with which probability the count of objects within the input image frame corresponds to a class of the plurality of classes. The classification layer provides for each class a probability. The output unit outputs the count of the class with the highest probability.

The classification layer results in a probability for every class. Other ways of generating the final output may, for example, taking the class with the maximum probability, or taking a value that is the average or weighted average of the top-x predictions.

The trained model may be tested in images from a target site that are natural images and captured by a camera and for a scene not experienced by the model at all during the training.

According to a further embodiment, the training unit is configured to train the plurality of convolutional layers and the plurality of fully connected layers starting from the highest layer and continuing successively to lower layers.

This provides that first, the highest layer is trained and subsequently, lower layers may be added.

Alternatively, all layers may be trained at once.

According to one or more of the present embodiments, the training unit is configured to provide a hierarchical training. A baseline model is used to increase the capability of the model by additionally using more complex images.

To increase the capability of the model to count a higher number of pedestrians, a hierarchical approach may be used. That provides that after creating a baseline model to count a certain number of pedestrians, this model may be used to create a model for counting higher number of pedestrians. With increasing counts of pedestrians, the complexity in the image increases due to different and complex ways in which occlusions occur. The rationale is to progressively increase the complexity of the training samples by including a higher number of pedestrians and occlusions while building on what the network has already learned from the simpler training samples. The hierarchical training method is suited for pedestrian counting since the categories of higher counts may be imagined to be supersets of the lower counts and hence may have some common features across counts that may be built on top of what is already learnt.

The suggested computer device, or some embodiments of the computer device, is based on the following approaches. Synthetic images may be used to generate a convolutional neural network (CNN) model in combination with transfer learning-application of the CNN model for pedestrian counting. Hierarchical training may enhance a pedestrian counting model capability for counting higher number of pedestrians. The cross entropy cost function may be established, where training is entirely on synthetic images and a model is required to generalize across scenes and acquisition devices.

The suggested computer device, or some embodiments of the computer device, provides the following advantages. Then, there is lack of sufficient annotated training data or perhaps none, for example, in the scenario where the camera or system is under development or the target site is inaccessible. It is a practical solution to deploy the model and still gives meaningful results. After setting up the system, it is possible to capture a few images for fine-tuning. Anotation efforts are not required since the training data is generated synthetically. Since no explicit detection of pedestrians is done, the training annotations are quite simple. Only a single number is required. No locations of the pedestrians or the bounding boxes are required. Since transfer learning is used, one may generate the models quickly. A full-fledged lengthy training is not required. A large amount of training data is not required as in the case for training a network from scratch. By using the cross entropy cost function, an indication of the range of estimates may be achieved instead of a single number. Besides, a generalization across scenes and cameras is possible. A good localization filter is learned for separating the background from the foreground even though the network was not explicitly told to do so. By fine-tuning using only the background of the target site, there is an improvement in the performance of the images from the target site.

According to a further aspect, a method for training a deep neural network is suggested. The method includes receiving a two-dimensional input image frame, and training a deep neural network using transfer learning based on synthetic images for generating a model comprising trained parameters. The deep neural network includes a plurality of hidden layers and an output layer representing a decision layer. The method also includes outputting a result of the deep neural network based on the model.

In a detection mode, the method may include receiving a two-dimensional input image frame, and examining the two-dimensional input image frame in view of objects being included in the two-dimensional input image frame using a deep neural network. The deep neural network includes a plurality of hidden layers and an output layer representing a decision layer based on classification and/or regression. The method includes outputting a result of the deep neural network.

The embodiments and features described with reference to the computer device of the present embodiments apply mutatis mutandis to the method of the present embodiments.

According to a further aspect, a computer program product is suggested. The computer program product includes a program code for executing the above-described method for training a deep neural network when run on at least one computer.

A computer program product, such as a computer program device, may be embodied as a memory card, USB stick, CD-ROM, DVD or as a file that may be downloaded from a server in a network. For example, such a file may be provided by transferring the file including the computer program product from a wireless communication network.

Further possible implementations or alternative solutions of the present embodiments also encompass combinations, which are not explicitly mentioned herein, of features described above or below with regard to the embodiments. The person skilled in the art may also add individual or isolated aspects and features to the most basic form of the invention.

### BRIEF DESCRIPTION OF THE DRAWINGS

FIG. 1 shows a schematic block diagram of a computer device for training a deep neural network in the absence of sufficient training data;

FIG. 2 shows a sequence of acts of a method for training a deep neural network in the absence of sufficient training data;

FIG. 3 shows a schematic block diagram of a method for training the neural network of FIG. 1;

FIG. 4 shows a schematic block diagram of the neural network; and

FIG. 5 shows a diagram illustrating a prediction of the count of pedestrians in a plurality of frames.

### DETAILED DESCRIPTION

In the Figures, like reference numerals designate like or functionally equivalent elements, unless otherwise indicated

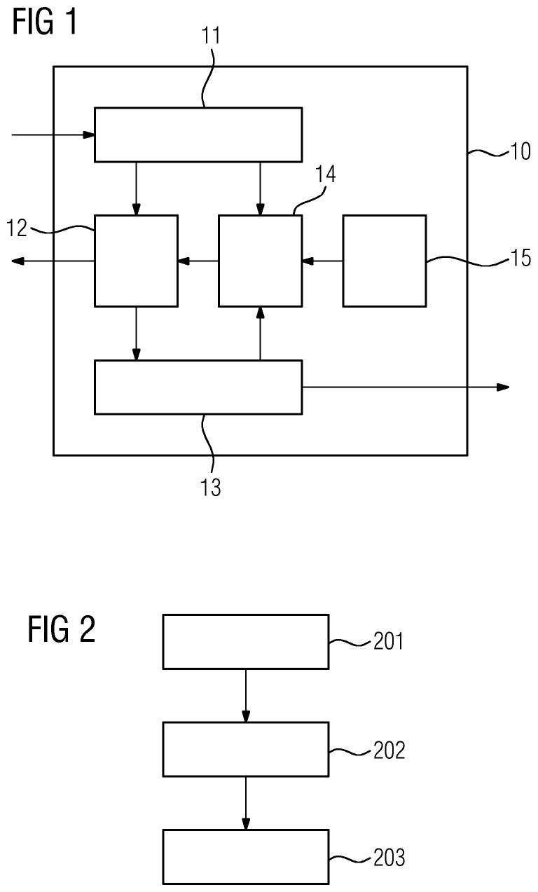

FIG. 1 shows a computer device 10 for training a deep neural network 12 (e.g., a neural network) in the absence of sufficient training data 1. The computer device 10 includes a receiving unit 11 (e.g. a receiver), the neural network 12, an output unit 13 (e.g., an output), a training unit (e.g., a trainer) 14, and a synthetic data generator 15.

The receiving unit 11 receives the two-dimensional input image frame. The neural network 12 examines the two-dimensional input image frame 1 in view of objects being included in the two-dimensional input image frame 1, and provides a count of the objects being included in the two-dimensional input image frame 1.

As shown in FIG. 4, the neural network 12 includes a plurality of convolutional layers 2 to 6 and a plurality of fully connected layers 7 to 9. The highest, or last, fully connected layer 9 is a classification layer for categorizing the two-dimensional input image frame 1 into one of a plurality of classes, where each class of the plurality of classes defines a specific count of the objects.

In a training mode, after the training iterations, a model (e.g., the parameters of the model obtained by training) is output by the network 12.

The training unit 14 may be used to train the neural network 12 to be able to, for example, detect the objects within a two-dimensional input frame 1 using, for example, synthetic images that may be generated by the synthetic data generator 15. The training unit 14 may train all layers 2 to 9 of the neural network 12 or may train only some of the layers (e.g., the convolutional layers 5 and 6 and the fully connected layers 7, 8 and 9, as indicated by the circle 50).

The output unit 13 outputs a result of the deep neural network (e.g., the count of objects within the two-dimensional input image frame 1) according to the estimation and categorization of the neural network 12.

In the training mode, the result of the network 12 is used for training the network 12 possibly for back propagation.

In a detection mode, the output unit 13 outputs the result of the network.

FIG. 2 illustrates a method for providing a count of objects within a two-dimensional input image frame 1. The method includes the following acts.

In a first act 201, the two-dimensional input image frame 1 is received.

In a second act 202, the deep neural network 12 is trained using transfer learning based on synthetic images 31.

In a third act 203, a result of the deep neural network 12 is output.

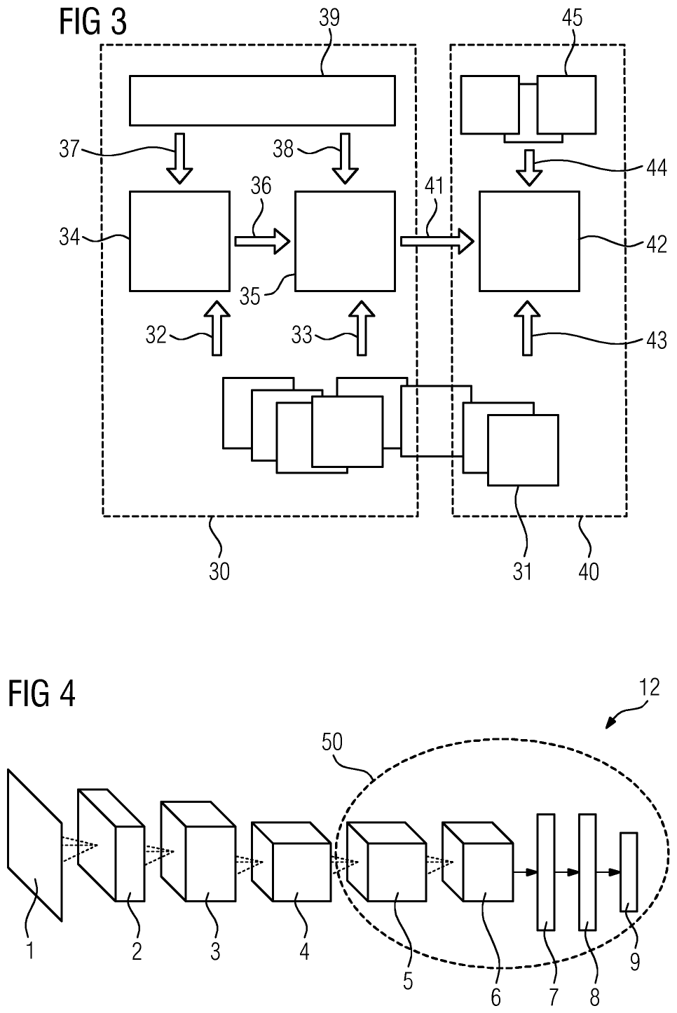

FIG. 3 shows an example of how the neural network 12 may be trained.

Using synthetically generated training data 31, the neural network 12 may be trained. Block 30 shows the basic training and block 31 shows the fine-tuning.

First, an initial neural network 39 is trained (arrow 32) using synthetic images based on transfer learning to create a baseline model 34. The baseline model 34 is further trained using a softmax activation with a cost function (arrow 37).

The baseline model 34 may be enhanced (34, 35) by tuning the baseline model 34 based on transfer learning to enhance the capability using the synthetic images 31 (arrow 33). In addition or alternatively, the initial model 39 may be enhanced based on transfer learning to the enhanced model 35 using a softmax activation with a cost function (arrow 38).

In the fine-tuning block 40, the enhanced model 35 may be fine-tuned (42) based on transfer learning using the synthetic images 31 (arrow 43). Further, the model 42 may be fine-tuned (44) using background images of a target site 45.

By including the background images in the training set in the category of the training set with zero pedestrians, the accuracy of the model may be increased.

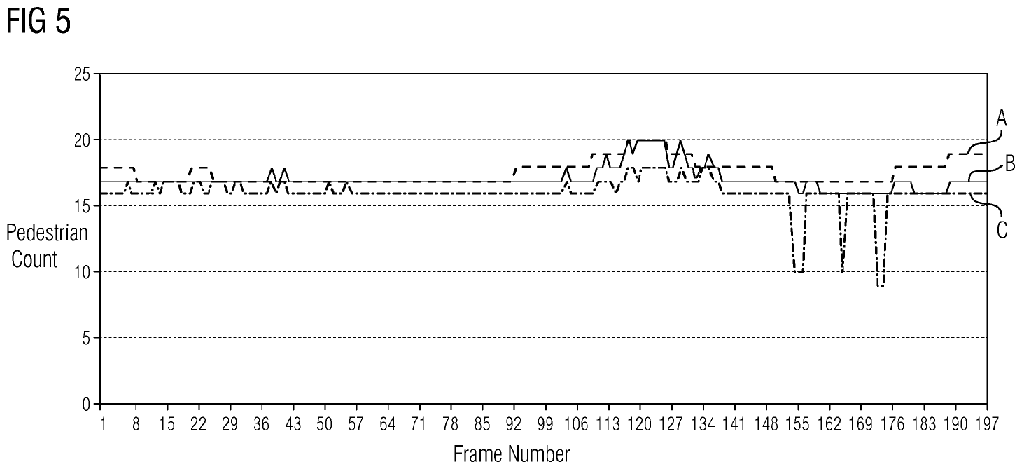

If the neural network 12 trained on synthetic images is fine-tuned using only the background of the target dataset, there is a significant improvement in the performance for the test data from the target site. The graph in FIG. 5 shows for a test sequence with 200 frames, the actual (curve A) and estimated pedestrian count using a model trained completely on synthetically generated images (curve C) and the improvement in the estimate obtained by fine-tuning using the background of the dataset (curve B).

Although the present invention has been described in accordance with exemplary embodiments, modifications are possible in all embodiments.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A computer device for training a deep neural network, the computer device comprising:
a receiver configured to receive a two-dimensional input image frame; a deep neural network configured to examine the two-dimensional input image frame in view of objects being included in the two-dimensional input image frame, wherein the deep neural network comprises a plurality of hidden layers and an output layer representing a decision layer;
a trainer configured to train the deep neural network using transfer learning based on synthetic images for generating a model comprising trained parameters; and
an output configured to output a result of the deep neural network based on the model,
wherein the trainer is further configured to provide a hierarchical training, and
wherein the hierarchical training includes using a baseline model to increase a capability of the model by additionally using more complex images.

2. The computer device of claim 1, wherein the output is further configured to feed back the result of the deep neural network to the training unit.

3. The computer device according to of claim 1, wherein the trainer is further configured to use an initial model of the deep neural network to initialize parameters of the deep neural network.

4. The computer device of claim 1, wherein the trainer is further configured to perform transfer learning from an initial model to a baseline model of the deep neural network, from the baseline model to an enhanced model of the deep neural network, from the initial model to the enhanced model of the deep neural network, and/or from the enhanced model to an improved model of the deep neural network, or any combination thereof.

5. The computer device of claim 1, further comprising a synthetic data generator configured to generate the synthetic images.

6. The computer device of claim 1, wherein the deep neural network is configured to provide as result a count of the objects in the two-dimensional input image frame.

7. The computer device of claim 1, wherein the objects are objects before a background of the two-dimensional input image frame.

8. The computer device of claim 1, wherein the objects are pedestrians.

9. The computer device of claim 1, wherein the trainer is further configured to train the deep neural network using a combination of an activation function, a linear neuron output in a first step and a cross entropy loss, a squared error loss in a second step, or any combination thereof.

10. The computer device of claim 9, wherein the trainer is further configured to train the deep neural network using regularization.

11. The computer device of claim 1, wherein the output layer is configured to provide a classification of the objects, is configured to provide a regression value, is configured to generate images, or any combination thereof.

12. The computer device of claim 1, wherein the result of the deep neural network includes a probability distribution, a single value, a decision, images, or any combination thereof.

13. A method for training a deep neural network, the method comprising:
receiving a two-dimensional input image frame;
training a deep neural network using transfer learning based on synthetic images for generating a model comprising trained parameters, wherein the deep neural network comprises a plurality of hidden layers and an output layer representing a decision layer; and
outputting a result of the deep neural network based on the model,
wherein the training is a hierarchical training,
wherein the hierarchical training includes using a baseline model to increase a capability of the model by additionally using more complex images.
